(19) United States
(12) Patent Application Publication
(10) Pub. No.: US 2013/0057508 A1
(43) Pub. Date: Mar. 7, 2013

(54) TOUCH PANEL

(71) Applicants: PO-SHENG SHIH, Zhubei (TW); PO-YANG CHEN, Zhubei (TW)

(72) Inventors: PO-SHENG SHIH, Zhubei (TW); PO-YANG CHEN, Zhubei (TW)

(73) Assignee: SHIH HUA TECHNOLOGY LTD., Zhubei City (TW)

(21) Appl. No.: 13/600,320

(22) Filed: Aug. 31, 2012

(30) Foreign Application Priority Data
Sep. 1, 2011 (TW) 100131401

(51) Int. Cl. G06F 3/045

(52) U.S. Cl. 345/174

(57) ABSTRACT

A touch panel includes an insulating substrate, a first conductive layer, and a second conductive layer. The insulating substrate has two opposite surfaces. The first conductive layer, fixed on one surface of the insulating substrate, has a minimum impedance along a first minimum impedance direction. The second conductive layer, fixed on the other surface of the insulating substrate, has a minimum impedance along a second minimum impedance direction. The first minimum impedance direction is substantially perpendicular to the second minimum impedance direction.

### CROSS-REFERENCE TO RELATED APPLICATIONS

This application claims all benefits accruing under 35 U.S.C. §119 from Taiwan Patent Application No. 100131401, filed on Sep. 1, 2011 in the Taiwan Intellectual Property Office, the disclosure of which is incorporated herein by reference.

### BACKGROUND

1. Technical Field

The present disclosure relates to a touch panel having a substrate, a conductive layer disposed on one surface of the substrate, and a carbon nanotube film disposed on another surface of the substrate.

2. Description of Related Art

In recent years, various electronic apparatuses, such as mobile phones, car navigation systems, have advanced toward high performances and diversifications. There is continuous growth in the number of electronic apparatuses equipped with optically transparent touch panels in front of the electronic apparatuses' display devices, such as liquid crystal panels. A user may operate the electronic apparatus by pressing a touch panel with a finger or a stylus while visually observing the display device through the touch panel. Thus, a demand exists for such touch panels with superior visibilities and reliabilities in operations. Due to high accuracy and low-cost productions of resistance-type touch panels, the resistance-type touch panels have been widely used.

A conventional resistance-type or capacitance-type touch panel includes a conductive indium tin oxide (ITO) layer as an optically transparent conductive layer. However, the ITO layer is generally formed by means of ion-beam sputtering and etched by laser beam, and the method is relatively complicated. Furthermore, the ITO layer has poor wear abilities, low chemical endurances and uneven resistances in an entire area of the panel. Additionally, the ITO layer has a relatively low transparency. With all the above-mentioned shortcomings, the conventional resistance-type touch panel with the ITO layer may has a low sensitivity, reduced accuracy, and reduced brightness.

What is needed, therefore, is to provide a touch panel which to overcome the shortcomings described above.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a top view of one embodiment of a touch panel.

FIG. 2 is a schematic view of the embodiment of the touch panel shown in FIG. 1.

FIG. 3 is a cross-section of the touch panel shown in FIG. 1 taken along a line III-III thereof.

FIG. 4 shows a Scanning Electron Microscope (SEM) image of one embodiment of a carbon nanotube film.

FIG. 5 is a circuit diagram of one embodiment of coupling the touch panel shown in FIG. 1 to a driving circuit and a scanning circuit.

FIG. 6 is a schematic view of one embodiment of coupling the touch panel shown in FIG. 1 to the driving circuit and the scanning circuit.

FIG. 7 is a time relationship diagram of scanning a number of second metal electrodes of the touch panel shown in FIG. 1.

FIG. 8 is a waveform chart of an electrical signal curve of non-touching the touch panel shown in FIG. 1.

FIG. 9 is a waveform chart of an electrical signal curve of touching the touch panel shown in FIG. 1.

FIG. 10 is a waveform chart of a readout characteristic curve of the touch panel shown in FIG. 1 after a scanning period.

FIG. 11 is a cross-section of one embodiment of a touch panel.

FIG. 12 is a schematic view of the embodiment of the touch panel shown in FIG. 11.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

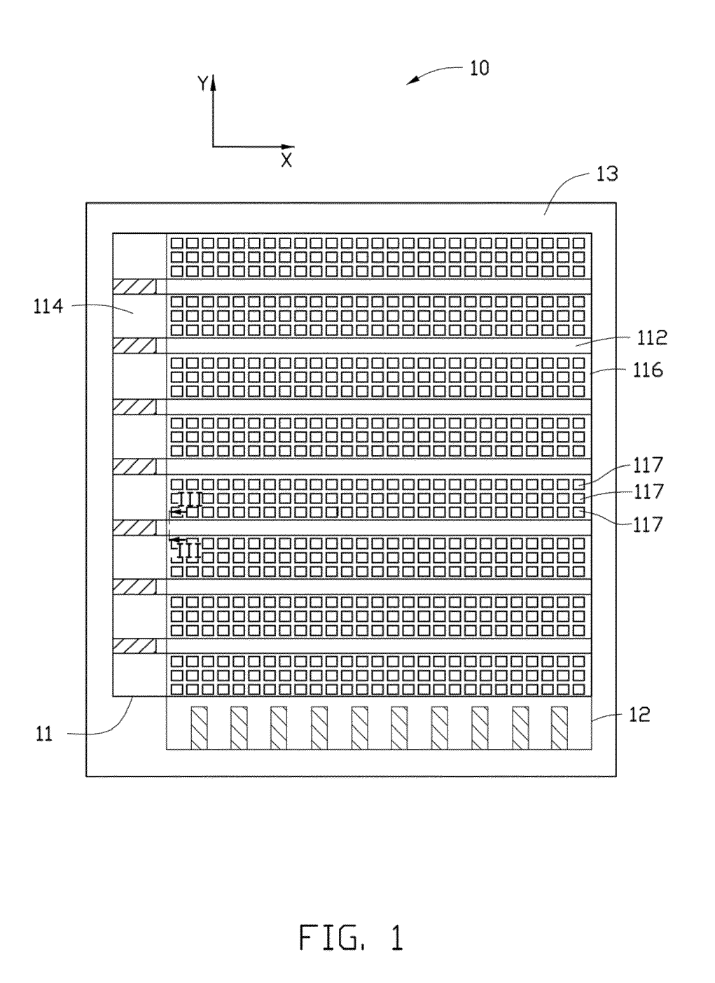

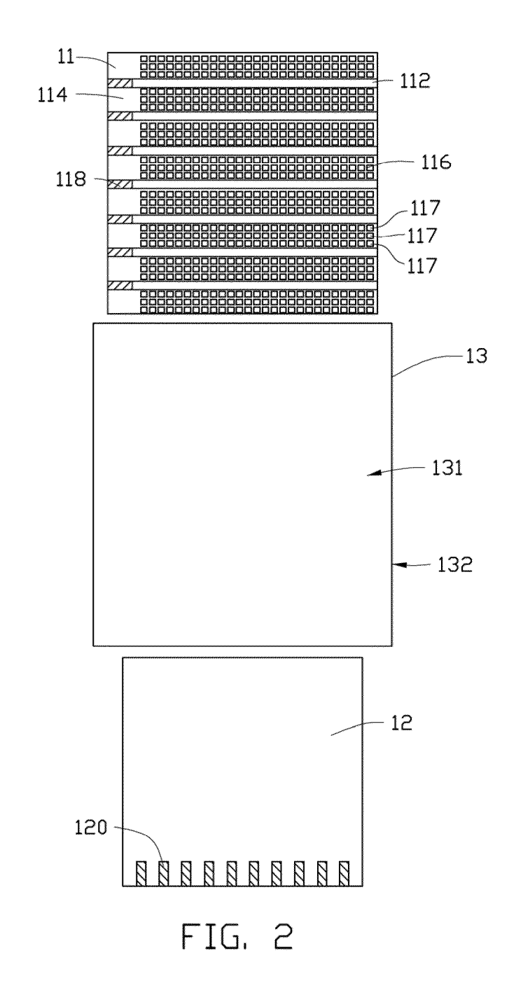

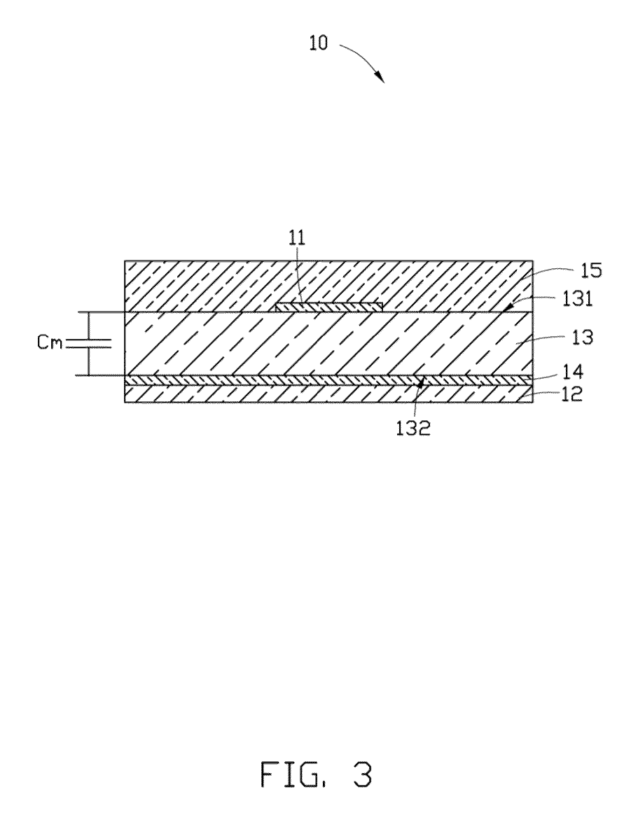

According to one embodiment, a touch panel 10 as illustrated in FIG. 1, FIG. 2 and FIG. 3 includes a first conductive layer 11, a second conductive layer 12, an insulating substrate 13, an adhesive layer 14, and a cover layer 15.

The insulating substrate 13 has a first surface 131 and a second surface 132 opposite to the first surface 131. The insulating substrate 13 which supports the first conductive layer 11 and the second conductive layer 12 can be formed from transparent material, such as polyethylene (PE), polycarbonate (PC), polyethylene terephthalate (PET), polymethyl methacrylate (PMMA), glass, or quartz. In one embodiment, the insulating substrate 13 is glass.

The first conductive layer 11 is fixed on the first surface 131 of the insulating substrate 13. The second conductive layer 12 is fixed on the second surface 132 of the insulating substrate 13. Impedance of the first conductive layer 11 is anisotropic. The first conductive layer 11 has a minimum impedance along a first minimum impedance direction. Similarly, impedance of the second conductive layer 12 is anisotropic. The second conductive layer 12 has a minimum impedance along a second minimum impedance direction. The first minimum impedance direction is substantially parallel to an X axis shown in FIG. 1. The second minimum impedance direction is substantially parallel to a Y axis shown in FIG. 1. The X axis is substantially perpendicular to the Y axis. In other words, the first minimum impedance direction is substantially perpendicular to the second minimum impedance direction.

There is a capacitance value Cm between the first conductive layer 11 and the second conductive layer 12. When a conductive subject (not shown) is near or touches the touch panel 10, the capacitance value Cm between the first conductive layer 11 and the second conductive layer 12 will be changed.

The first conductive layer 11 includes a number of transparent conductive belts 112, a number of regular intervals 114, a filler 116, and a number of first metal electrodes 118. Each adjacent two of the transparent conductive belts 112 are disposed on the first conductive layer 11 with one of the regular intervals 114 and substantially parallel to each other. The widths of the transparent conductive belts 112 are substantially the same. The transparent conductive belts 112 substantially extend along the X axis. In other words, the transparent conductive belts 112 substantially extend along the first minimum impedance direction of the first conductive layer 11. Each of the transparent conductive belts 112 can be formed from transparent material with a reflective index, such as indium tin oxide (ITO). In one embodiment, the transparent conductive belts 112 are a number of bar-shaped ITO films.

The widths of the regular intervals 114 are substantially the same. A ratio of one of the widths of the transparent conductive belts 112 to one of the widths of the regular intervals 114 is from about 1:20 to about 1:2. In one embodiment, one of the widths of the transparent conductive belts 112 is from about 0.25 millimeter (mm) to about 2.5 mm when one of the widths of the regular intervals 114 is about 5 mm.

The filler 116 is filled into each of the regular intervals 114. The filler 116 can be formed from transparent material with a reflective index which matches the refractive index of each of the transparent conductive belts 112. In one embodiment, the reflective index of each of the transparent conductive belts 112 is same as the reflective index of the filler 116. The filler 116 is formed from ITO. In the embodiment, the filler 116 includes a number of cubes 117 formed from ITO. The cubes 117 disposed in the regular intervals 114.

The second conductive layer 12 includes a number of second metal electrodes 120 and is adhered to the second surface 132 of the insulating substrate 13 via the adhesive layer 14. The adhesive layer 14 can be formed from pressure-sensitive adhesive, heat-sensitive adhesive, or light-sensitive adhesive. A thickness of the adhesive layer 14 can be in the range from about 4 micrometer (um) to about 8 um. In one embodiment, the adhesive layer 14 is UV adhesive. The thickness of the adhesive layer 14 is about 5 um.

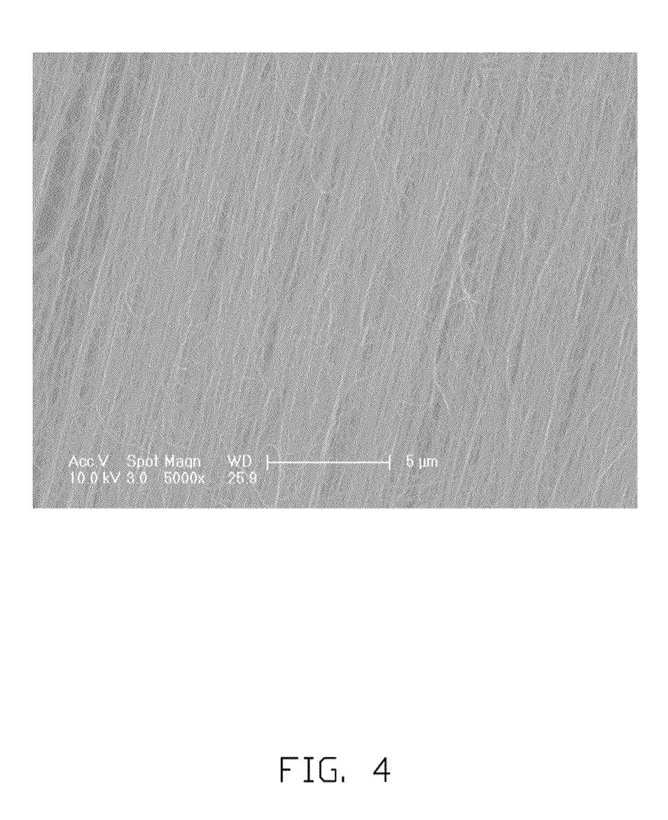

Referring to FIG. 4, the second conductive layer 12 is a drawn carbon nanotube film. The drawn carbon nanotube film can be pulled/drawn from a carbon nanotube array, and includes a number of carbon nanotubes. Each of the carbon nanotubes defines a preferred orientation direction. The carbon nanotubes are arranged successively along the preferred orientation direction and joined side-to-side and end-to-end along the preferred orientation direct by van der Waals force therebetween.

The carbon nanotubes can be single-walled carbon nanotubes, double-walled carbon nanotubes, multi-walled carbon nanotubes, or any combination thereof. The diameter of the single-walled carbon nanotubes can be in the range from about 0.5 nanometer (nm) to about 50 nm. The diameter of the double-walled carbon nanotubes can be in the range from about 1 nm to about 50 nm. The diameter of the multi-walled carbon nanotubes can be in the range from about 1.5 nm to about 50 nm. The length of the carbon nanotubes can be greater than 50 um.

The drawn carbon nanotube film is a freestanding film, meaning that the drawn carbon nanotube film does not need to be supported by a substrate and can sustain it's own weight when it is hoisted by a portion thereof without tearing. The drawn carbon nanotube film has minimum impedance along the stretching direction of the successive and oriented carbon nanotubes and maximum impedance along the direction perpendicular to the stretching direction of the successive and oriented carbon nanotubes so as to have anisotropic impedance. In one embodiment, the successive and oriented carbon nanotubes substantially extend along the second minimum impedance direction of the second conductive layer 12. The second impedance direction of the second conductive layer 12 is substantially defined as the stretching direction of the successive and oriented carbon nanotubes.

The cover layer 15 covers the first conductive layer 11 fixed on the first surface 131 of the insulating substrate 13. The cover layer 15 which covers the first conductive layer 11 can be formed from transparent material, such as polyethylene (PE), polycarbonate (PC), polyethylene terephthalate (PET), polymethyl methacrylate (PMMA), or thin glass.

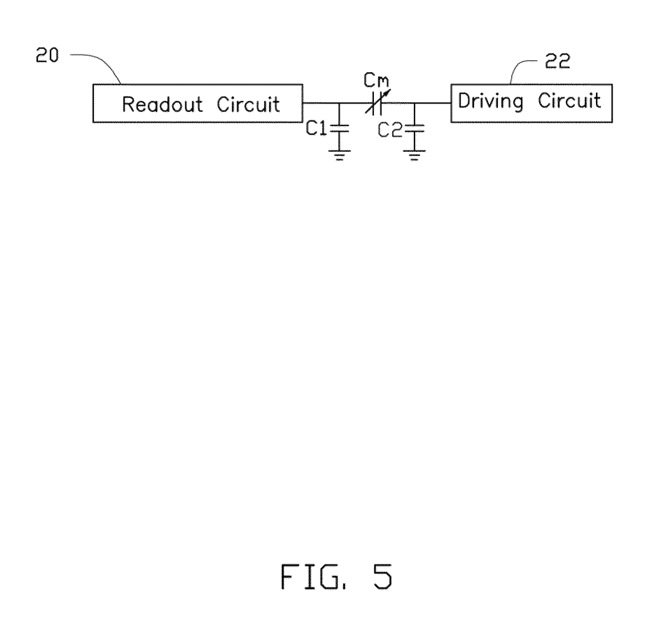

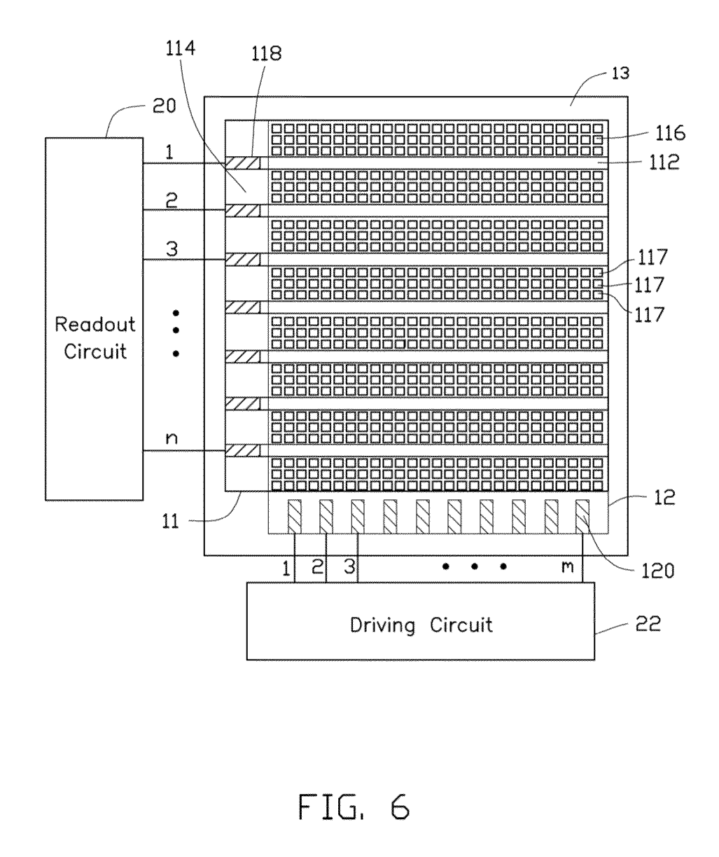

Referring to FIG. 5 and FIG. 6, the touch panel 10 further comprises a readout circuit 20, a driving circuit 22, a number of readout lines 1, 2, . . . , n, and a number of scanning lines 1, 2, . . . , m. The first conductive layer 11 is electrically coupled to the readout circuit 20. The second conductive layer 12 is electrically coupled to the driving circuit 22. In the embodiment, each of the first metal electrodes 118 has two ends. One end of each of the first metal electrodes 118 is electrically connected to the readout circuit 20, and the other end of each of the first metal electrodes 118 is electrically connected to the corresponding transparent conductive belts 112. Similarly, each of the second metal electrodes 120 has two ends. One end of each of the second metal electrodes 120 is electrically connected to the driving circuit 22, and the other end of each of the second metal electrodes 120 is electrically connected to the second conductive layer 12. There is a capacitance value C1 between the first conductive layer 11 and a grounding contact. There is a capacitance value C2 between the second conductive layer 12 and the grounding contact.

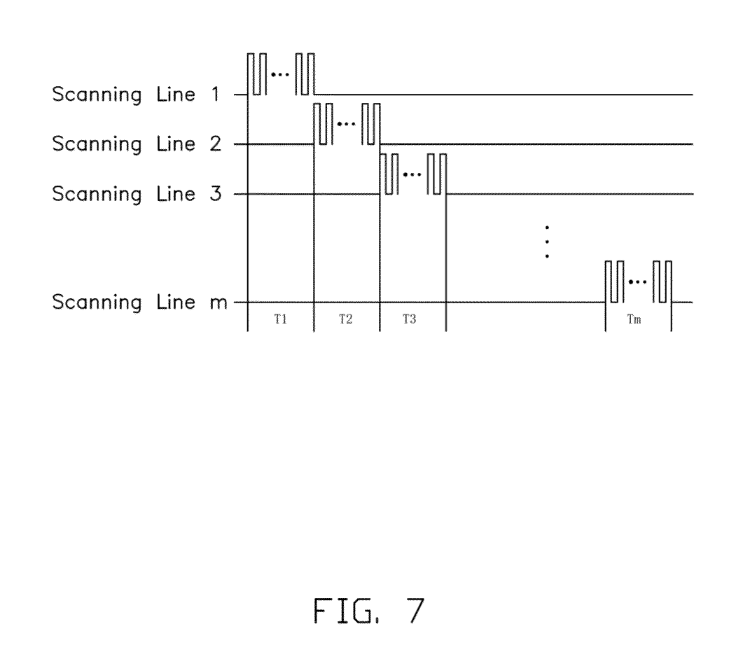

Referring to FIG. 7, a number of square signals are respectively inputted into the scanning lines 1, 2, . . . , m in turn to achieve a scanning period. In the embodiment, the driving circuit 22 inputs a first square signal to the scanning lines 1 during a time period T1. Afterward, the readout circuit 20 receives a number of voltages from the readout lines 1, 2, . . . , n. Similarly, the driving circuit 22 inputs a second square signal to the scanning lines 2 during a time period T2. Afterward, the readout circuit 20 receives a number of voltages from the readout lines 1, 2, . . . , n. Finally, the driving circuit 22 inputs an m square signal to the scanning lines m during a time period Tm. Afterward, the readout circuit 20 receives a number of voltages from the readout lines 1, 2, . . . , n.

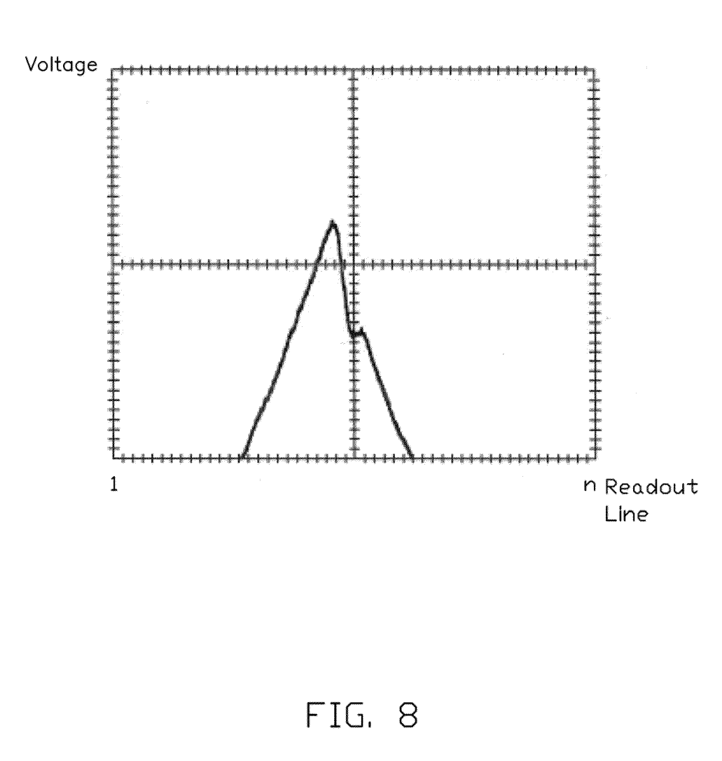

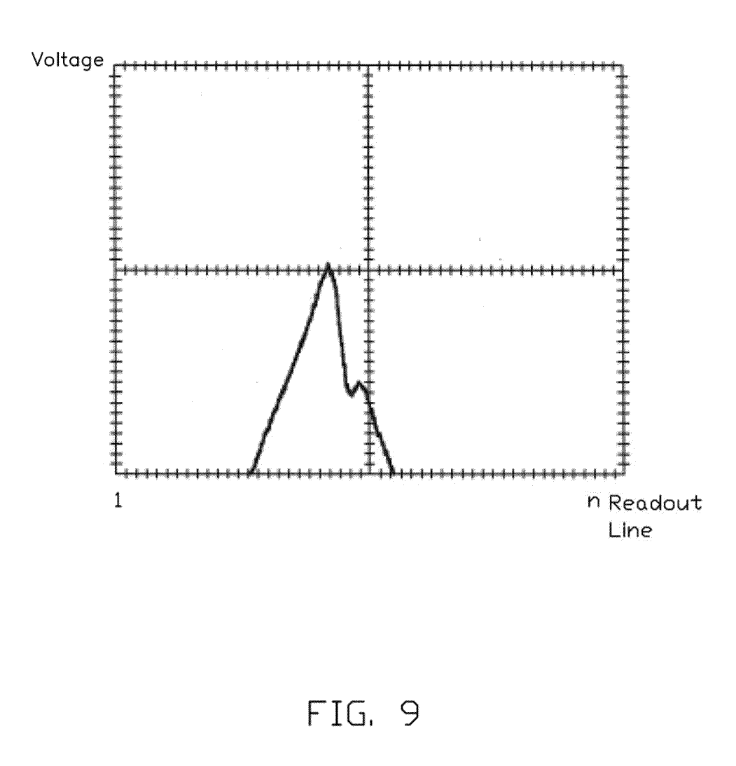

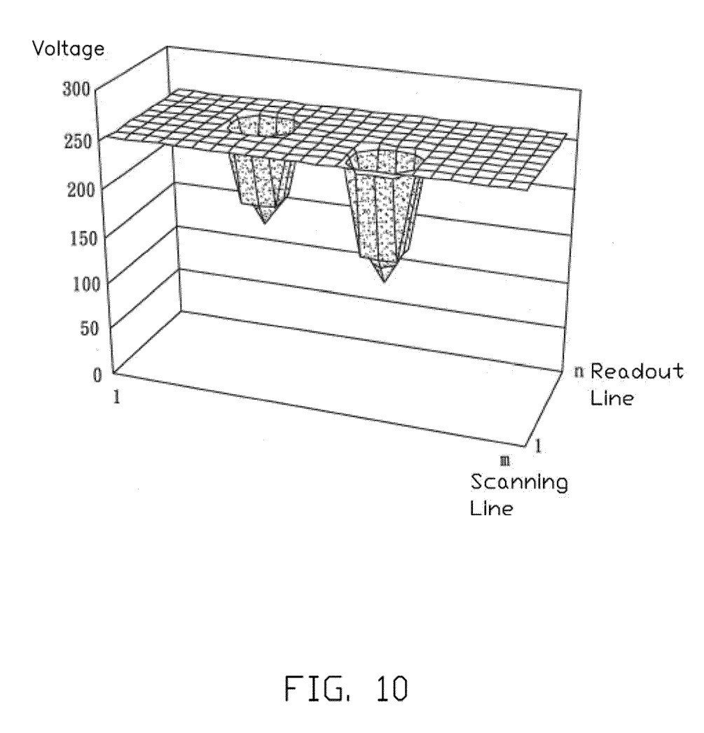

After a scanning period, the readout circuit 20 receives m*n voltages from the readout lines 1, 2, . . . , n. Referring to FIG. 8, an electrical signal curve of non-touching the touch panel 10 is shown. Referring to FIG. 9, an electrical signal curve of touching the touch panel 10 is shown. An amplitude of the touching of the touch panel 10 is smaller than an amplitude of the non-touching of the touch panel 10. Referring to FIG. 10, a readout characteristic curve of the touch panel 10 is formed by the m*n voltages after the scanning period. As shown in FIG. 10, there are two smallest voltages representing two touch spots of touching the touch panel 10.

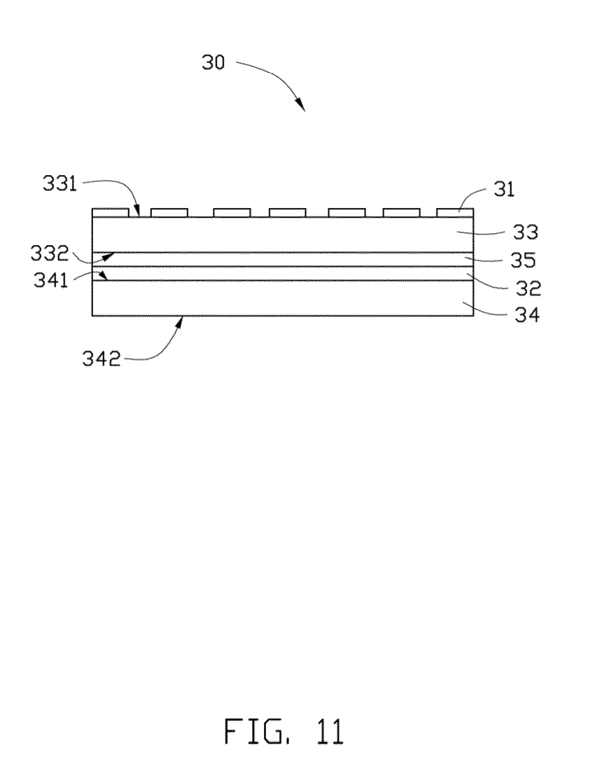

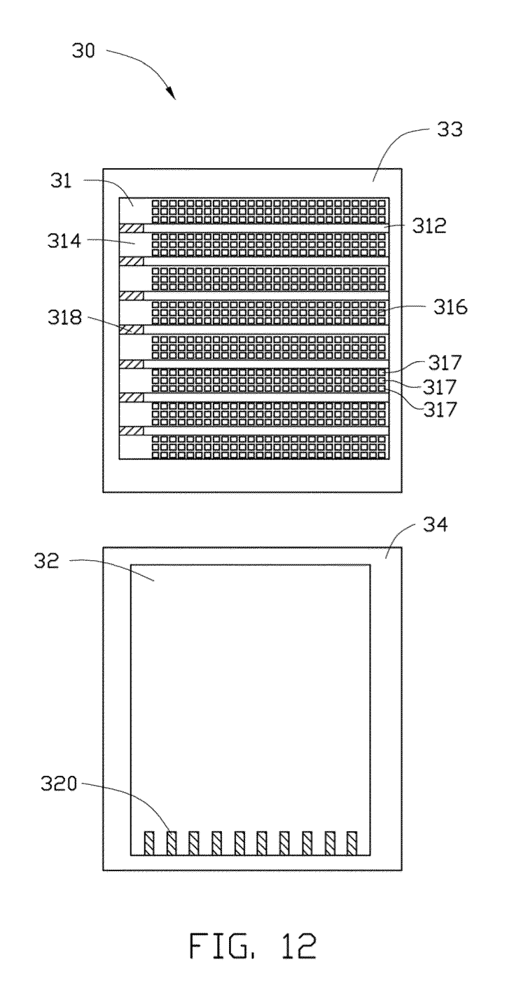

According to another embodiment, a touch panel 30 as illustrated in FIG. 11 and FIG. 12 includes a first conductive layer 31, a second conductive layer 32, a first insulating substrate 33, a second insulating substrate 34, and an adhesive layer 35.

The first insulating substrate 33 has a first surface 331 and a second surface 332 opposite to the first surface 331. The second insulating substrate 34 has a first surface 341 and a second surface 342 opposite to the first surface 341. The first insulating substrate 33 which supports the first conductive layer 31 and the second insulating substrate 34 which supports the second conductive layer 32 can be formed from transparent material, such as polyethylene (PE), polycarbonate (PC), polyethylene terephthalate (PET), polymethyl methacrylate (PMMA), glass, or quartz.

The first conductive layer 31 is fixed on the first surface 331 of the first insulating substrate 33. The second conductive layer 32 is fixed on the first surface 341 of the second insulating substrate 34. The first conductive layer 31 has anisotropic impedance and defines a first minimum impedance direction. The second conductive layer 32 has anisotropic impedance and defines a second minimum impedance direction. The first minimum impedance direction is substantially perpendicular to the second minimum impedance direction.

The first conductive layer 31 includes a number of transparent conductive belts 312, a number of regular intervals 314, a filler 316, and a number of first metal electrodes 318. Each adjacent two of the transparent conductive belts 312 are disposed on the first conductive layer 31 with one of the regular intervals 314 and substantially parallel to each other. The widths of the transparent conductive belts 312 are substantially the same. The transparent conductive belts 312 substantially extend along the first minimum impedance direction of the first conductive layer 31. Each of the transparent conductive belts 312 can be formed from transparent material with a reflective index, such as indium tin oxide (ITO). In one embodiment, the transparent conductive belts 312 are a number of bar-shaped ITO films.

The widths of the regular intervals 314 are substantially the same. A ratio of one of the widths of the transparent conductive belts 312 to one of the widths of the regular intervals 314 is from about 1:20 to about 1:2. In one embodiment, one of the widths of the transparent conductive belts 312 is from about 0.25 mm to about 2.5 mm when one of the widths of the regular intervals 314 is about 5 mm.

The filler 316 is filled into each of the regular intervals 314. The filler 316 can be formed from transparent material with a reflective index which matches the refractive index of each of the transparent conductive belts 312. In one embodiment, the reflective index of each of the transparent conductive belts 312 is same as the reflective index of the filler 316. The filler 316 is formed from ITO. In the embodiment, the filler 316 includes a number of cubes 317 formed from ITO. The cubes 317 disposed in the regular intervals 314.

Each of the first metal electrodes 318 has two ends. One end of each of the first metal electrodes 318 is electrically connected to the corresponding transparent conductive belts 312.

The second conductive layer 32 includes a number of second metal electrodes 320 and is adhered to the second surface 332 of the first insulating substrate 33 via the adhesive layer 35. The adhesive layer 35 can be formed from pressure-sensitive adhesive, heat-sensitive adhesive, or light-sensitive adhesive. A thickness of the adhesive layer 35 can be in the range from about 4 um to about 8 um. In one embodiment, the adhesive layer 35 is UV adhesive. The thickness of the adhesive layer 35 is about 5 um.

Each of the second metal electrodes 320 has two ends. One end of each of the second metal electrodes 320 is electrically connected to the second conductive layer 32. The second conductive layer 32 is a drawn carbon nanotube film. The drawn carbon nanotube film can be pulled/drawn from a carbon nanotube array, and includes a number of successive and oriented carbon nanotubes joined end-to-end by van der Waals force therebetween.

The carbon nanotubes can be single-walled carbon nanotubes, double-walled carbon nanotubes, multi-walled carbon nanotubes, or any combination thereof. The diameter of the single-walled carbon nanotubes can be in the range from about 0.5 nm to about 50 nm. The diameter of the double-walled carbon nanotubes can be in the range from about 1 nm to about 50 nm. The diameter of the multi-walled carbon nanotubes can be in the range from about 1.5 nm to about 50 nm. The length of the carbon nanotubes can be greater than 50 um.

The drawn carbon nanotube film is a freestanding film, meaning that the drawn carbon nanotube film does not need to be supported by a substrate and can sustain it's own weight when it is hoisted by a portion thereof without tearing. The drawn carbon nanotube film has minimum impedance along the stretching direction of the successive and oriented carbon nanotubes and maximum impedance along the direction perpendicular to the stretching direction of the successive and oriented carbon nanotubes so as to have anisotropic impedance. In one embodiment, the successive and oriented carbon nanotubes substantially extend along the second minimum impedance direction of the second conductive layer 32. The second impedance direction of the second conductive layer 32 is substantially defined as the stretching direction of the successive and oriented carbon nanotubes.

Accordingly, the present disclosure is capable of providing a touch panel, which detects a touch spot by a conductive layer and a carbon nanotube film disposed at two opposite sides of an insulating substrate and improve the precision of detecting the touch spot.

Finally, it is to be understood that the above-described embodiments are intended to illustrate rather than limit the present disclosure. Variations may be made to the embodiments without departing from the spirit of the disclosure as claimed. Elements associated with any of the above embodiments are envisioned to be associated with any other embodiments. The above-described embodiments illustrate the scope of the disclosure but do not restrict the scope of the disclosure.

What is claimed is:

1. A touch panel, comprising:
an insulating substrate comprising a first surface and a second surface opposite to the first surface;
a first conductive layer fixed on the first surface of the insulating substrate, impedance of the first conductive layer being anisotropic; and
a second conductive layer fixed on the second surface of the insulating substrate, impedance of the second conductive layer being anisotropic,
wherein the first conductive layer having a minimum impedance along a first minimum impedance direction, the second conductive layer having a minimum impedance along a second minimum impedance direction, and the first minimum impedance direction is substantially perpendicular to the second minimum impedance direction.

2. The touch panel as claimed in claim 1, wherein the first conductive layer comprises a plurality of transparent conductive belts disposed on the first conductive layer at a regular interval and the plurality of transparent conductive belts being substantially parallel to each other.

3. The touch panel as claimed in claim 2, wherein the plurality of transparent conductive belts substantially extend along the first minimum impedance direction of the first conductive layer.

4. The touch panel as claimed in claim 2, wherein the first conductive layer further comprises a filler filled into each of the regular interval.

5. The touch panel as claimed in claim 4, wherein a reflective index of each of the plurality of transparent conductive belts is same as a reflective index of the filler.

6. The touch panel as claimed in claim 4, wherein the filler is formed from indium tin oxide (ITO).

7. The touch panel as claimed in claim 2, wherein the first conductive layer further comprises a plurality of cubes disposed in each of the regular interval.

8. The touch panel as claimed in claim 2, wherein each of the plurality of transparent conductive belts has a same width, and each of the regular interval has a same width.

9. The touch panel as claimed in claim 2, wherein each of the plurality of transparent conductive belts is a bar-shaped ITO film.

10. The touch panel as claimed in claim 1, wherein the second conductive layer is a carbon nanotube film comprising a plurality of carbon nanotubes, each of the plurality of carbon nanotubes defining a preferred orientation direction, the plurality of carbon nanotubes being arranged successively along the preferred orientation direction and being joined side-to-side and end-to-end along the preferred orientation direct by van der Waals force therebetween.

11. The touch panel as claimed in claim 10, wherein the plurality of carbon nanotubes substantially extend along the second minimum impedance direction of the second conductive layer.

12. A touch panel, comprising:
an insulating substrate comprising a first surface and a second surface opposite to the first surface;
a first conductive layer fixed on the first surface of the insulating substrate, impedance of the first conductive layer being anisotropic, wherein the first conductive layer comprises a plurality of transparent conductive belts deposed on the first conductive layer at a regular interval, and a plurality of cubes disposed in each of the regular interval, the plurality of transparent conductive belts being substantially parallel to each other; and
a second conductive layer fixed on the second surface of the insulating substrate, impedance of the second conductive layer being anisotropic,
wherein the first conductive layer having a minimum impedance along a first minimum impedance direction, the second conductive layer having a minimum impedance along a second minimum impedance direction, and the first minimum impedance direction is substantially perpendicular to the second minimum impedance direction.

13. The touch panel as claimed in claim 12, wherein the plurality of transparent conductive belts substantially extend along the first minimum impedance direction of the first conductive layer.

14. The touch panel as claimed in claim 12, wherein each of the plurality of transparent conductive belts has a same width, and each of the regular interval has a same width.

15. The touch panel as claimed in claim 12, wherein each of the plurality of transparent conductive belts is a bar-shaped ITO film.

16. The touch panel as claimed in claim 12, wherein the second conductive layer is a carbon nanotube film comprising a plurality of carbon nanotubes, each of the plurality of carbon nanotubes defining a preferred orientation direction, the plurality of carbon nanotubes being arranged successively along the preferred orientation direction and being joined side-to-side and end-to-end along the preferred orientation direct by van der Waals force therebetween.

17. The touch panel as claimed in claim 16, wherein the plurality of carbon nanotubes substantially extend along the second minimum impedance direction of the second conductive layer.

18. A touch panel, comprising:
a first insulating substrate comprising a first surface and a second surface opposite to the first surface;
a first conductive layer fixed on the first surface of the first insulating substrate, impedance of the first conductive layer being anisotropic;
a second insulating substrate having a first surface and a second surface opposite to the first surface;
a second conductive layer fixed on the first surface of the second insulating substrate, impedance of the second conductive layer being anisotropic; and
an adhesive layer configured to adhere the first insulating substrate and the second conductive layer together,
wherein the first conductive layer having a minimum impedance along a first minimum impedance direction, the second conductive layer having a minimum impedance along a second minimum impedance direction, and the first minimum impedance direction is substantially perpendicular to the second minimum impedance direction.

19. The touch panel as claimed in claim 18, wherein the first conductive layer comprises a plurality of transparent conductive belts disposed on the first conductive layer at a regular interval, the plurality of transparent conductive belts being substantially parallel to each other, and the plurality of transparent conductive belts substantially being configured to extend along the first minimum impedance direction of the first conductive layer.

20. The touch panel as claimed in claim 18, wherein the second conductive layer is a carbon nanotube film comprising a plurality of carbon nanotubes, each of the plurality of carbon nanotubes defining a preferred orientation direction, the plurality of carbon nanotubes being arranged successively along the preferred orientation direction and being joined side-to-side and end-to-end by van der Waals force therebetween, and the plurality of carbon nanotubes being configured to substantially extend along the second minimum impedance direction of the second conductive layer.
